(19) United States
(12) Patent Application Publication
(10) Pub. No.: US 2020/0027241 A1
(43) Pub. Date: Jan. 23, 2020

(54) AUTO-CALIBRATION FOR VEHICLE CAMERAS

(71) Applicant: GM GLOBAL TECHNOLOGY OPERATIONS LLC, Detroit, MI (US)

(72) Inventors: Wei Tong, Troy, MI (US); Shuqing Zeng, Sterling Heights, MI (US)

(73) Assignee: GM GLOBAL TECHNOLOGY OPERATIONS LLC, Detroit, MI (US)

(21) Appl. No.: 16/039,640

(22) Filed: Jul. 19, 2018

(51) Int. Cl. G06T 7/80; G06K 9/00; G06K 9/62; G06T 7/55; G06K 9/03; G06T 3/00; H04N 5/232

(52) U.S. Cl. CPC G06T 7/80; G06K 9/00798; G06K 9/6215; G01C 21/3667; G06K 9/03; G06T 3/0068; H04N 5/232; G06T 7/55

(57) ABSTRACT

In various embodiments, methods, systems, and vehicles are provided for calibrating vehicle cameras. In certain embodiments, a vehicle includes a camera, a memory, and a processor. The camera is disposed onboard the vehicle, and is configured to generate a camera image in which an object is detected onboard the vehicle. The memory is configured to store map data relating to the detected object. The processor is disposed onboard the vehicle, and is configured to perform an initial projection using the map data and initial values of calibration parameters for the camera; and update values of the calibration parameters using a comparison of the initial projection with the camera image.

### TECHNICAL FIELD

The technical field generally relates to vehicles and, more specifically, to methods and systems for calibrating cameras for vehicles.

### BACKGROUND

Many vehicles include cameras, including cross traffic cameras for detecting objects in proximity to the vehicle. However, calibration errors may be present, for example for use in projecting two-dimensional camera images onto a three-dimensional space. It may be desirable, in certain situations, for a calibration of a vehicle's cameras to be improved, for example for projecting two-dimensional camera images onto a three-dimensional space.

Accordingly, it is desirable to provide improved methods and systems for calibrating vehicle cameras. Furthermore, other desirable features and characteristics of the present invention will become apparent from the subsequent detailed description of the invention and the appended claims, taken in conjunction with the accompanying drawings and this background of the invention.

### SUMMARY

In one exemplary embodiment, a method is provided. The method includes obtaining a camera image from a camera onboard a vehicle; detecting an object in proximity to the vehicle from the camera image; obtaining map data relating to the detected object; performing, via a processor, an initial projection using the map data and initial values of calibration parameters for the camera; and updating, via the processor, values of the calibration parameters using a comparison of the initial projection with the camera image.

Also in one embodiment, the step of detecting the object includes detecting a feature of a roadway in proximity to the vehicle; and the step of obtaining the map data includes obtaining the map data relating the feature of the roadway.

Also in one embodiment, the step of performing the initial projection includes performing, via the processor, an initial lane projection using a known lane from the map data and the initial values of calibration parameters for the camera; and the step of updating the calibration parameters includes updating, via the processor, the calibration parameters using a comparison of the initial lane projection with a corresponding lane from the camera image.

Also in one embodiment, the step of performing the initial projection includes: randomly selecting a plurality of points along the known lane from the map data; and generating an initial projected lane using the set of points and the initial values of the calibration parameters, utilizing the following equation: qᵢ=R pᵢ+T, in which “pᵢ” represents one of the plurality of randomly selected points from the known lane from the map data, “qᵢ” represents a corresponding projected point on the initial projected lane, “R” represents an initial value of a rotation matrix for the camera, and “T” represents an initial value of a translation vector for the camera.

Also in one embodiment, the step of updating the calibration parameters includes: identifying corresponding nearest neighbor points between the known lane from the map data and corresponding projected points of the initial projected lane; calculating respective distances between each of the projected points and their corresponding nearest neighbor points; and determining the calibration parameters based on the distances.

Also in one embodiment, the calibration parameters include a rotation matrix “R” for the camera and a translation vector “T” for the camera, and the step of determining the calibration parameters is performed in accordance with the following equation:

$$arg {min}_{R , T} {\sum }_{i = 1}^{k} {d}_{i} ,$$

in which “dᵢ” represents the respective distances between each of the projected points and their corresponding nearest neighbor points for each of a plurality of selected pairs of points from the known lane and the initial projected lane, and “k” represents a number of selected pairs of points.

Also in one embodiment, the method further includes: calculating an error for the calibration parameters based on the initial values of the calibration parameters and the updating of values of the calibration parameters; and providing further updates for the calibration parameters in an iterative fashion using subsequent projections using the map data and the updated values of the calibration parameters, until the error for the calibration parameters is less than a predetermined threshold, to thereby align the initial projection and the camera image.

Also in one embodiment, the method further includes: providing updated projections of the camera image onto a three-dimensional space using the updated values of the calibration parameters; and taking a vehicle action, in accordance with instructions provided via the processor, based on the updated projections.

In another exemplary embodiment, a system is provided. The system includes an image module and a processing module. The image module is configured to obtain a camera image from a camera onboard a vehicle; detect an object in proximity to the vehicle from the camera image; and obtain map data relating to the detected object. The processing module is configured to perform, via a processor, an initial projection using the map data and initial values of calibration parameters for the camera; and update, via the processor, values of the calibration parameters using a comparison of the initial projection with the camera image.

Also in one embodiment, the image module is configured to detect a feature of a roadway in proximity to the vehicle; and obtain the map data relating the feature of the roadway; and the processing module is configured to perform an initial lane projection using a known lane from the map data and the initial values of calibration parameters for the camera; and update the calibration parameters using a comparison of the initial lane projection with a corresponding lane from the camera image.

Also in one embodiment, the processing module is configured to randomly select a plurality of points along the known lane from the map data; and generate an initial projected lane using the set of points and the initial values of the calibration parameters, utilizing the following equation: qᵢ=R pᵢ+T, in which “pᵢ” represents one of the plurality of randomly selected points from the known lane from the map data, “qᵢ” represents a corresponding projected point on the initial projected lane, “R” represents an initial value of a rotation matrix for the camera, and “T” represents an initial value of a translation vector for the camera.

Also in one embodiment, the calibration parameters include a rotation matrix “R” for the camera and a translation vector “T” for the camera, and the processing module is configured to: identify corresponding nearest neighbor points between the known lane from the map data and corresponding projected points of the initial projected lane; calculate respective distances between each of the projected points and their corresponding nearest neighbor points; and determine the calibration parameters based on the distances, in accordance with the following equation:

$$arg {min}_{R , T} {\sum }_{i = 1}^{k} {d}_{i} ,$$

in which “dᵢ” represents the respective distances between each of the projected points and their corresponding nearest neighbor points for each of a plurality of selected pairs of points from the known lane and the initial projected lane, and “k” represents a number of selected pairs of points.

Also in one embodiment, the processing module is configured to calculate an error for the calibration parameters based on the initial values of the calibration parameters and the updating of values of the calibration parameters; and provide further updates for the calibration parameters in an iterative fashion using subsequent projections using the map data and the updated values of the calibration parameters, until the error for the calibration parameters is less than a predetermined threshold, to thereby align the initial projection and the camera image.

Also in one embodiment, the processing module is configured to: provide updated projections of the camera image onto a three-dimensional space using the updated values of the calibration parameters; and provide instructions for taking a vehicle action, based on the updated projections.

In another exemplary embodiment, a vehicle is provided. The vehicle includes a body, a propulsion system, a camera, a memory, and a processor. The propulsion system is configured to generate movement of the body. The camera is disposed onboard the vehicle, and is configured to generate a camera image in which an object is detected onboard the vehicle. The memory is configured to store map data relating to the detected object. The processor is disposed onboard the vehicle, and is configured to: perform an initial projection using the map data and initial values of calibration parameters for the camera; and update values of the calibration parameters using a comparison of the initial projection with the camera image.

Also in one embodiment, the detected object includes a feature of a roadway in proximity to the vehicle; the map data relates to the feature of the roadway; and the processor is configured to: perform an initial lane projection using a known lane from the map data and the initial values of calibration parameters for the camera; and update the calibration parameters using a comparison of the initial lane projection with a corresponding lane from the camera image.

Also in one embodiment, the processor configured to randomly select a plurality of points along the known lane from the map data; and generate an initial projected lane using the set of points and the initial values of the calibration parameters, utilizing the following equation: qᵢ=R pᵢ+T, in which “pᵢ” represents one of the plurality of randomly selected points from the known lane from the map data, “qᵢ” represents a corresponding projected point on the initial projected lane, “R” represents an initial value of a rotation matrix for the camera, and “T” represents an initial value of a translation vector for the camera.

Also in one embodiment, the calibration parameters include a rotation matrix “R” for the camera and a translation vector “T” for the camera, and the processor is configured to: identify corresponding nearest neighbor points between the known lane from the map data and corresponding projected points of the initial projected lane; calculate respective distances between each of the projected points and their corresponding nearest neighbor points; and determine the calibration parameters based on the distances, in accordance with the following equation:

$$\_ arg {min}_{R , T} {\sum }_{i = 1}^{k} {d}_{i} ,$$

in which “dᵢ” represents the respective distances between each of the projected points and their corresponding nearest neighbor points for each of a plurality of selected pairs of points from the known lane and the initial projected lane, and “k” represents a number of selected pairs of points.

Also in one embodiment, the processor is configured to: calculate an error for the calibration parameters based on the initial values of the calibration parameters and the updating of values of the calibration parameters; and provide further updates for the calibration parameters in an iterative fashion using subsequent projections using the map data and the updated values of the calibration parameters, until the error for the calibration parameters is less than a predetermined threshold, to thereby align the initial projection and the camera image.

Also in one embodiment, the processor is configured to: provide updated projections of the camera image onto a three-dimensional space using the updated values of the calibration parameters; and provide instructions for taking a vehicle action, based on the updated projections.

### DESCRIPTION OF THE DRAWINGS

The present disclosure will hereinafter be described in conjunction with the following drawing figures, wherein like numerals denote like elements, and wherein:

FIG. 1 is a functional block diagram of a vehicle that includes cameras and a control system for calibrating the cameras, in accordance with exemplary embodiments;

FIG. 2 is a block diagram of modules of the control system of FIG. 1, in accordance with exemplary embodiments;

FIG. 3 is a flowchart of a process for calibrating vehicle cameras, and that can be implemented in connection with the vehicle, cameras, and control system of FIGS. 1 and 2, in accordance with exemplary embodiments;

FIG. 4 provides an exemplary depiction of a roadway on which the vehicle is travelling, in an implementation of the process of FIG. 3, in accordance with exemplary embodiments;

FIG. 5 provides representations of exemplary projected lanes using a camera image and map data, in an implementation of the process of FIG. 3, in accordance with exemplary embodiments;

FIG. 6 provides a first exemplary set of projections of a camera image onto a three-dimensional space, using initial and updated rotation matrix “R” and translation vector “T” calibrations, in an implementation of the process of FIG. 3, in accordance with exemplary embodiments;

FIG. 7 provides a second exemplary set of projections of a camera image onto a three-dimensional space, using initial and updated rotation matrix “R” and translation vector “T” calibrations, in an implementation of the process of FIG. 3, in accordance with exemplary embodiments; and

FIG. 8 is a flowchart of a sub-process for the process of FIG. 3, namely, a sub-process for determining updated parameters for the cameras, in accordance with exemplary embodiments.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

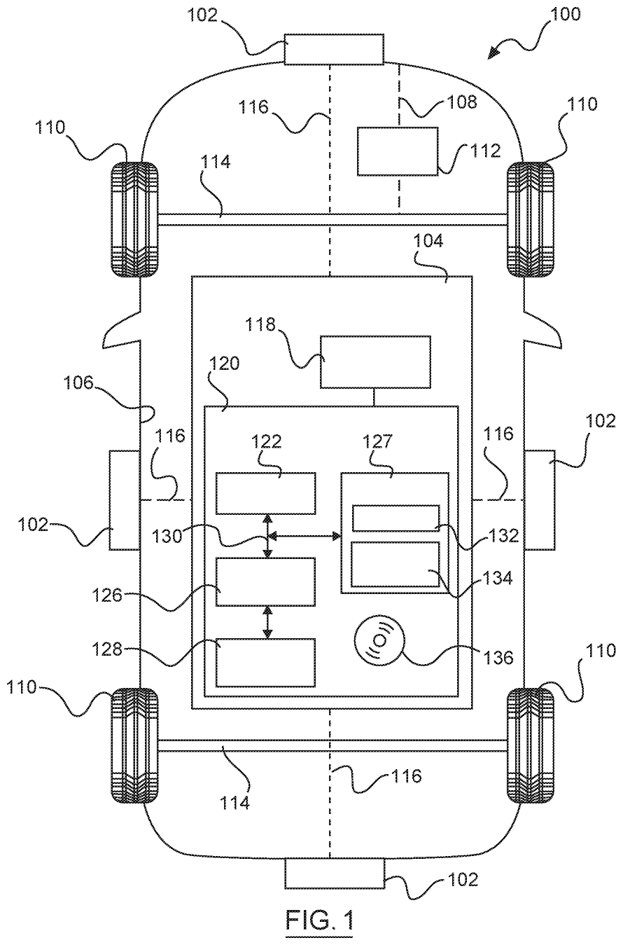

FIG. 1 illustrates a vehicle 100, according to an exemplary embodiment. As described in greater detail further below, the vehicle 100 includes cameras 102 and a control system 104.

In certain embodiments, the cameras 102 are controlled via a control system 104, as depicted in FIG. 1. Also in certain embodiments, the control system 104 calibrates the cameras 102 for use in projecting the camera images onto a three-dimensional space.

In various embodiments, the vehicle 100 comprises an automobile. The vehicle 100 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles in certain embodiments. In certain embodiments, the vehicle 100 may also comprise a motorcycle or other vehicle, and/or one or more other types of mobile platforms (e.g., a robot, a ship, and so on) and/or other systems, for example having a camera image with a fixed referenced point.

The vehicle 100 includes a body 106 that is arranged on a chassis 108. The body 106 substantially encloses other components of the vehicle 100. The body 106 and the chassis 108 may jointly form a frame. The vehicle 100 also includes a plurality of wheels 110. The wheels 110 are each rotationally coupled to the chassis 108 near a respective corner of the body 106 to facilitate movement of the vehicle 100. In one embodiment, the vehicle 100 includes four wheels 110, although this may vary in other embodiments (for example for trucks and certain other vehicles).

A drive system 112 is mounted on the chassis 108, and drives the wheels 110, for example via axles 114. The drive system 112 preferably comprises a propulsion system. In certain exemplary embodiments, the drive system 112 comprises an internal combustion engine and/or an electric motor/generator, coupled with a transmission thereof. In certain embodiments, the drive system 112 may vary, and/or two or more drive systems 112 may be used. By way of example, the vehicle 100 may also incorporate any one of, or combination of, a number of different types of propulsion systems, such as, for example, a gasoline or diesel fueled combustion engine, a “flex fuel vehicle” (FFV) engine (i.e., using a mixture of gasoline and alcohol), a gaseous compound (e.g., hydrogen and/or natural gas) fueled engine, a combustion/electric motor hybrid engine, and an electric motor.

As depicted in FIG. 1, in certain embodiments, the cameras 102 include a rear vision camera that is mounted on a rear portion of the vehicle 100, a front vision camera that is mounted on a front portion of the vehicle 100, a driver side camera that is mounted on a driver side of the vehicle 100, and a passenger side camera that is mounted on a passenger side of the vehicle. In various embodiments, the cameras 102 capture images of the vehicle and the surrounding environment of the vehicle, for example in detecting other vehicles, other objects, a roadway, roadway features, and the like from various sides of the vehicle 100 (e.g., front side, rear side, passenger side, and driver side), for example to assist the vehicle 100 in travelling along a roadway (e.g., to avoid contact with other vehicles and/or other objects). In certain embodiments, cameras 102 may also be disposed on one or more other locations of the vehicle 100, for example on top of the vehicle 100, for example to create a surround view and/or one or more other views for the vehicle 100. In various embodiments, the cameras 102 are configured to generate images of cross directional traffic in proximity to the vehicle 100. In various embodiments, the number, locations, and/or placement of the cameras 102 may vary (e.g., in certain embodiments, a single camera may be used, and so on).

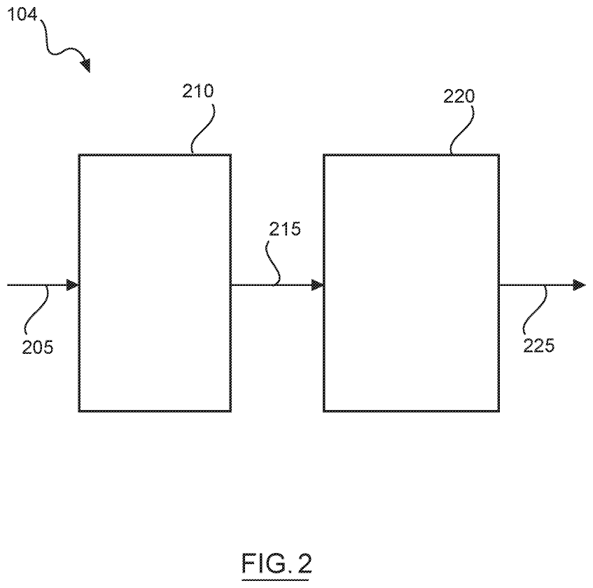

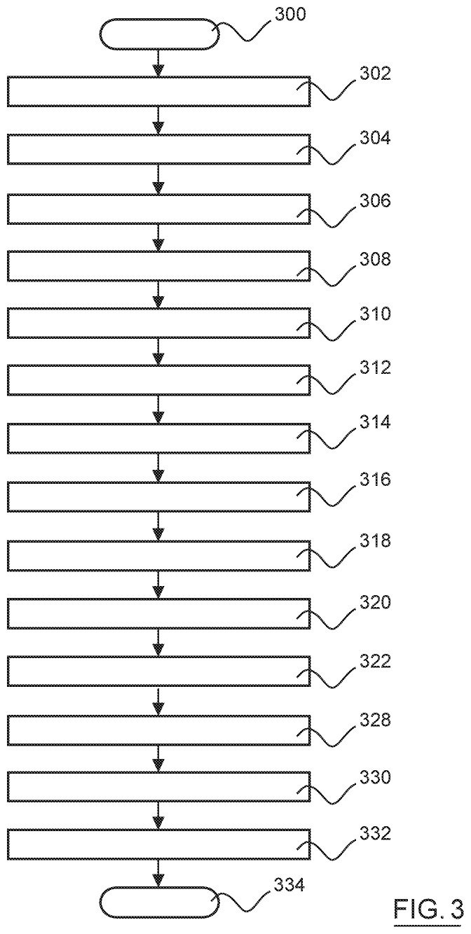

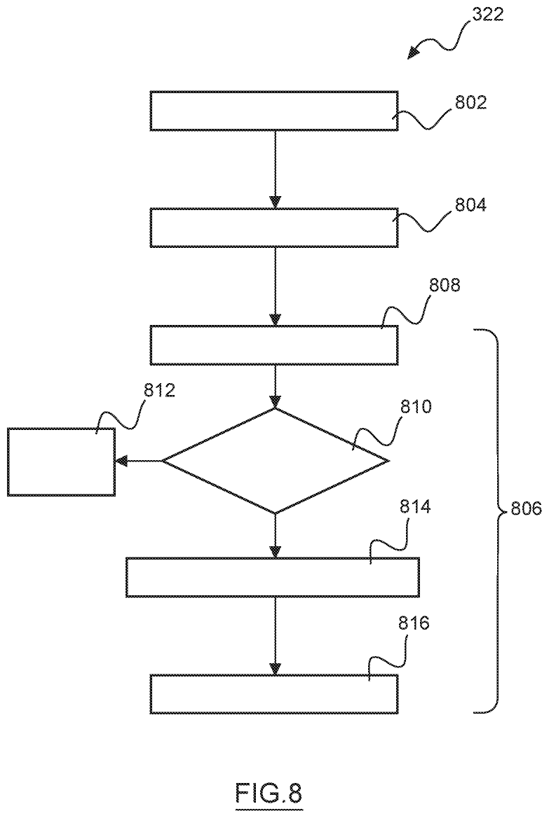

In various embodiments, the control system 104 controls operation of the cameras, and (as alluded to above) calibrates the cameras 102, for example for use in projecting the camera images onto a three-dimensional space. In various embodiments, the control system 104 provides these and other functions in accordance with the steps of the process of FIG. 3, the implementations of FIGS. 2, 4-7, and the sub-process of FIG. 8.

In various embodiments, the control system 104 is disposed within the body 106 of the vehicle 100. In one embodiment, the control system 104 is mounted on the chassis 108. In certain embodiments, the control system 104 and/or one or more components thereof may be disposed outside the body 106, for example on a remote server, in the cloud, or in a remote smart phone or other device where image processing is performed remotely. In addition, in certain embodiments, the control system 104 may be disposed within and/or as part of the cameras 102 and/or within and/or or as part of one or more other vehicle systems.

Also, as depicted in FIG. 1, in various embodiments the control system 104 is coupled to the cameras 102 via one or more communications links 116, and receives camera images from the cameras 102 via the communications links 116. In certain embodiments, each communications link 116 comprises one or more wired connections, such as one or more cables (e.g. coaxial cables and/or one or more other types of cables). In other embodiments, each communications link 116 may comprise one or more wireless connections, e.g., using one or more transceivers.

As depicted in FIG. 1, the control system 104 includes a navigation system 118 and a controller 120. In various embodiments, the navigation system 118 provides location information for the vehicle 100. For example, in various embodiments, the navigation system 118 comprises a satellite-based system (e.g., with antennas and/or transceivers disposed onboard the vehicle 100), such as a global positioning system (GPS) and/or other satellite-based system, and provides location information regarding a current position of the vehicle 100. In certain embodiments, the navigation system 118, and/or one or more components thereof, may be disposed within and/or be part of the control system 104. In other embodiments, the navigation system 118 may be coupled to the control system 104.

The controller 120 controls operation of the control system 104, and the cameras 102. Specifically, in various embodiments, the controller 120 controls calibration of the cameras 102, for example for projecting two-dimensional camera images onto a three-dimensional space. Also in certain embodiments, the controller 120 may take and/or provide instructions for one or more vehicle actions for the vehicle 100 (e.g., providing automatic braking and/or steering, automatic notifications, and so on) based on the camera images and/or the projections of the camera images. In various embodiments, the controller 120 provides these and other functions in accordance with the steps of the process 300 discussed further below in connection with FIG. 3, the implementations of FIGS. 2, 4-7, and the sub-process of FIG. 8.

In one embodiment, the controller 120 is coupled to the cameras 102. Also in one embodiment, the controller 120 is disposed within the control system 104, within the vehicle 100. In certain embodiments, the controller 120 (and/or components thereof, such as the processor 122 and/or other components) may be part of and/or disposed within the cameras 102 and/or one or more other vehicle components. Also in certain embodiments, the controller 120 may be disposed in one or more other locations of the vehicle 100. In addition, in certain embodiments, multiple controllers 120 may be utilized (e.g. one controller 120 within the vehicle 100 and another controller within the cameras 102, among other possible variations). In addition, in certain embodiments, the controllers 120 can be placed outside the vehicle, such as in a remote server, in the cloud or on a remote smart device.

As depicted in FIG. 1, the controller 120 comprises a computer system. In certain embodiments, the controller 120 may also include the cameras 102, the navigation system 118, and/or one or more components thereof. In addition, it will be appreciated that the controller 120 may otherwise differ from the embodiment depicted in FIG. 1. For example, the controller 120 may be coupled to or may otherwise utilize one or more remote computer systems and/or other control systems, for example as part of one or more of the above-identified vehicle 100 devices and systems.

In the depicted embodiment, the computer system of the controller 120 includes a processor 122, a memory 124, an interface 126, a storage device 128, and a bus 130. The processor 122 performs the computation and control functions of the controller 120, and may comprise any type of processor or multiple processors, single integrated circuits such as a microprocessor, or any suitable number of integrated circuit devices and/or circuit boards working in cooperation to accomplish the functions of a processing unit. During operation, the processor 122 executes one or more programs 132 contained within the memory 124 and, as such, controls the general operation of the controller 120 and the computer system of the controller 120, generally in executing the processes described herein, such as the process 300 discussed further below in connection with FIG. 3, the implementations of FIGS. 2, 4-7, and the sub-process of FIG. 8.

The memory 124 can be any type of suitable memory. For example, the memory 124 may include various types of dynamic random access memory (DRAM) such as SDRAM, the various types of static RAM (SRAM), and the various types of non-volatile memory (PROM, EPROM, and flash). In certain examples, the memory 124 is located on and/or co-located on the same computer chip as the processor 122. In the depicted embodiment, the memory 124 stores the above-referenced program 132 along with one or more stored values 134 (e.g., including, in various embodiments, previous calibrations as well as map data pertaining to roadways on which the vehicle 100 is being driven along with features of such roadways, and the like).

The bus 130 serves to transmit programs, data, status and other information or signals between the various components of the computer system of the controller 120. The interface 126 allows communication to the computer system of the controller 120, for example from a system driver and/or another computer system, and can be implemented using any suitable method and apparatus. In one embodiment, the interface 126 obtains the various data from the cameras 102 and the navigation system 118. The interface 126 can include one or more network interfaces to communicate with other systems or components. The interface 126 may also include one or more network interfaces to communicate with technicians, and/or one or more storage interfaces to connect to storage apparatuses, such as the storage device 128.

The storage device 128 can be any suitable type of storage apparatus, including various different types of direct access storage and/or other memory devices. In one exemplary embodiment, the storage device 128 comprises a program product from which memory 124 can receive a program 132 that executes one or more embodiments of one or more processes of the present disclosure, such as the steps of the process 300 discussed further below in connection with FIG. 3, the implementations of FIGS. 2, 4-7, and the sub-process of FIG. 8. In another exemplary embodiment, the program product may be directly stored in and/or otherwise accessed by the memory 124 and/or a disk (e.g., disk 136), such as that referenced below.

The bus 130 can be any suitable physical or logical means of connecting computer systems and components. This includes, but is not limited to, direct hard-wired connections, fiber optics, infrared and wireless bus technologies. During operation, the program 132 is stored in the memory 124 and executed by the processor 122.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 122) to perform and execute the program. Such a program product may take a variety of forms, and the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links. It will be appreciated that cloud-based storage and/or other techniques may also be utilized in certain embodiments. It will similarly be appreciated that the computer system of the controller 120 may also otherwise differ from the embodiment depicted in FIG. 1, for example in that the computer system of the controller 120 may be coupled to or may otherwise utilize one or more remote computer systems and/or other control systems.

FIG. 2 provides a functional block diagram for modules of the control system 104 of FIG. 1, in accordance with exemplary embodiments. As depicted in FIG. 2, in various embodiments, the control system 104 generally includes an image module 210 and a processing module 220. In various embodiments, the image module 210 and processing module 220 are disposed onboard the vehicle 100. As can be appreciated, in certain embodiments, parts of the control system 104 may be disposed on a system remote from the vehicle 100 while other parts of the control system 104 may be disposed on the vehicle 100.

In various embodiments, the image module 210 obtains cameras images from the cameras 102 of FIG. 1. In various embodiments, the image module 210 obtains two-dimensional camera images from the cameras 102 via one or more communications links 116 of FIG. 1. In various embodiments, the image module 210 obtains the camera images as inputs 205, as shown in FIG. 2.

Also in various embodiments, the image module 210 also obtains location information (including navigation and map information) as part of the inputs 205. Specifically, in certain embodiments, one or more objects (e.g., other vehicles, and/or roadway features such as curbs, stop lights, stop signs, light posts, and the like) are detected via the camera images, and the image module 210 obtains navigation information (e.g., from the navigation system 118 of FIG. 1) pertaining to a location of the vehicle 100 and map information (e.g., from the stored values 134 of the memory 124 of FIG. 1) pertaining to a known location of the detected objects, and known lanes of roadways in proximity thereto. In addition, in certain embodiments, the inputs as include the existing calibration parameters to the camera (e.g., the parameters that will be updated using the process 200 for improved projection accuracy).

Also in various embodiments, the image module 210 provides information pertaining to the camera images, existing camera calibration parameters and location information (e.g., navigation and map information) as outputs 215 for use by the processing module 220, for example as discussed below.

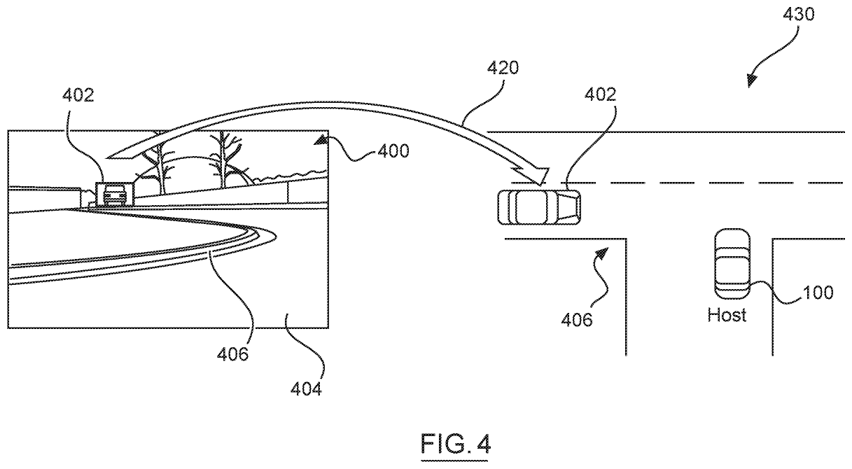

In various embodiments, the processing module 220 utilizes the camera images, existing calibration parameters and location information (e.g., navigation and map information) as inputs 215 for the processing module 220, and calibrates the cameras 102 of the vehicle 100 using the camera images existing calibration information and location information. Specifically, in certain embodiments, the processing module 220 calibrates the cameras 102 for use in projecting the camera images onto a three-dimensional space, using the location information, for example as described in greater detail below in connection with the process 300 of FIG. 3, the implementations of FIGS. 4-7, and the sub-process of FIG. 8. In various embodiments, the camera calibrations are provided by the processing module 220 to the cameras 102 as outputs 225 from the processing module 220.

In addition, in various embodiments, the processing module 220 may provide instructions for initiating one or more vehicle actions for the vehicle 100 (e.g., providing automatic braking and/or steering, automatic notifications, and so on) based on the camera images and/or the projections of the camera images (e.g., based on an updated projection of the roadway and objects thereon or in proximity thereto). In various embodiments, such instructions may be provided also as part of the outputs 225 of the processing module 220, for example for implementation by one or more other vehicle systems (e.g., as outputs to a brake system, steering system, and so on).

FIG. 3 is a flowchart of a process 300 for calibrating cameras of a vehicle (and taking related vehicle actions), in accordance with exemplary embodiments. The process 300 can be implemented in connection with the vehicle 100, cameras 102 and control system 104 of FIGS. 1 and 2, in accordance with exemplary embodiments. The process 300 of FIG. 3 will also be discussed further below in connection and FIGS. 4-7, which show different implementations of the process 300 in accordance with various embodiments, and FIG. 8, which shows an exemplary sub-process of the process 300 for determining updated parameters in accordance with various embodiments.

As depicted in FIG. 3, the process begins at step 301. In one embodiment, the process 300 begins when a vehicle drive or ignition cycle begins, for example when a driver approaches or enters the vehicle 100, or when the driver turns on the vehicle and/or an ignition therefor (e.g. by turning a key, engaging a keyfob or start button, and so on). In one embodiment, the steps of the process 300 are performed continuously during operation of the vehicle.

Camera images are obtained for the vehicle (step 302). In various embodiments, camera images are obtained from one or more of the cameras 102 of the vehicle 100 of FIG. 1. In certain embodiments, the camera images also include two-dimensional still images from one or more points of view for the vehicle 100. In certain embodiments, two-dimensional video images may also be obtained. In various embodiments, camera images are obtained for cross directional traffic in proximity to the vehicle 100. In various embodiments, the camera data is obtained by the cameras 102 as part of the image module 210 and provided to the processor 122.

Navigation data is obtained for the vehicle (step 304). In various embodiments, navigation data is obtained via the navigation system 118 of FIG. 1 (e.g., a GPS system) pertaining to a location of the vehicle 100. In certain embodiments, such navigation information is obtained using information from one or more satellites, and includes longitudinal and latitudinal coordinates for the vehicle 100 (e.g., as part of the image module 210 of FIG. 2).

Objects are detected in proximity to the vehicle (step 306). In various embodiments, the camera images of step 302 are utilized in detecting various objects in proximity to the vehicle 100 and/or in proximity to a path of the vehicle 100. Specifically, in various embodiments, one or more other vehicles (also referred to herein as target vehicles) may be detected, along with one or more features of a roadway on which the vehicle 100 is driving or nearby the vehicle 100 (such as a curb, traffic light, stop sign, light post, lane, and so on), and/or one or more other types of objects in proximity to the vehicle 100. In various embodiments, the objects may be detected by the cameras 102 themselves of FIG. 1 (e.g., as part of the image module 210 of FIG. 2), and/or using the processor 122 of FIG. 1.

Map data is obtained (step 308). In various embodiments, map data is obtained with respect to the vehicle 100, the roadway on which the vehicle 100 is travelling, and the features of the roadway (e.g., such as a curb, traffic light, stop sign, light post, lane, and so on, as detected via the cameras 102). In various embodiments, the map data includes known coordinates (e.g., latitudinal and longitudinal) for known features of the roadway that are detected via the camera images. In various embodiments, the map data is obtained via the stored values 134 of the memory 124 of FIG. 1, for example as part of the image module 210 of FIG. 2. Alternatively, in certain embodiments, the map data may be obtained from one or more remote servers remote from the vehicle 100.

With reference to FIG. 4, an exemplary depiction 400 is shown of a roadway 404 on which the vehicle 100 is travelling. As shown in FIG. 4, a target vehicle 402 is detected along the roadway 404, along with a curb 406 that is a feature of the roadway 404. Also shown in FIG. 4 is an exemplary projection 420 of the target vehicle 402 and roadway 404 onto a map 430 using the camera images. In such an embodiment, the map data may be generated based on the detected curb 406 and/or one or more lanes of the roadway 404, for example, in combination with a known location of the vehicle 100 based on the navigation (e.g., GPS) data.

With reference back to FIG. 3, camera parameters are initialized (step 310). In certain embodiments, for each camera 102, a rotation matrix (“R”) and a translation vector (“T”) are initialized based on an initial calibration of the cameras 102. In certain embodiments, the initialized values of “R” and “T” are retrieved from the memory 124 of FIG. 1 (as stored values 134 thereof) based on one or more prior calibrations, such as during vehicle manufacturing, vehicle testing, and/or one or more prior iterations of the process 300 (e.g., prior to or during a current ignition cycle or vehicle drive). In certain embodiments, the initialized values are retrieved from the memory 124 via the processor 122 of FIG. 1 (e.g., as part of the processing module 220 of FIG. 2).

One or more lanes in the map information are identified (step 312). In various embodiments, different lanes are identified, based on the map data of step 308, for a roadway on which the vehicle 100 is travelling, as well as other lanes that are in proximity to the vehicle 100 and/or a path of the vehicle 100. In various embodiments, the lanes are identified using the map information in combination with the detected objects (e.g., a detected curb, lane, or other feature of the roadway) and the navigation data (e.g. GPS data). In certain embodiments, the lanes are identified by the processor 122 of FIG. 1 (e.g., as part of the processing module 220 of FIG. 2), and the subsequent steps of the process 300 are performed with respect to each of the identified lanes.

For each of the identified lanes, points are sampled along the lane (step 314). In various embodiments, the processor 122 of FIG. 1 (e.g., as part of the processing module 220 of FIG. 2) randomly samples a plurality of points along the lane, for each of the identified lanes.

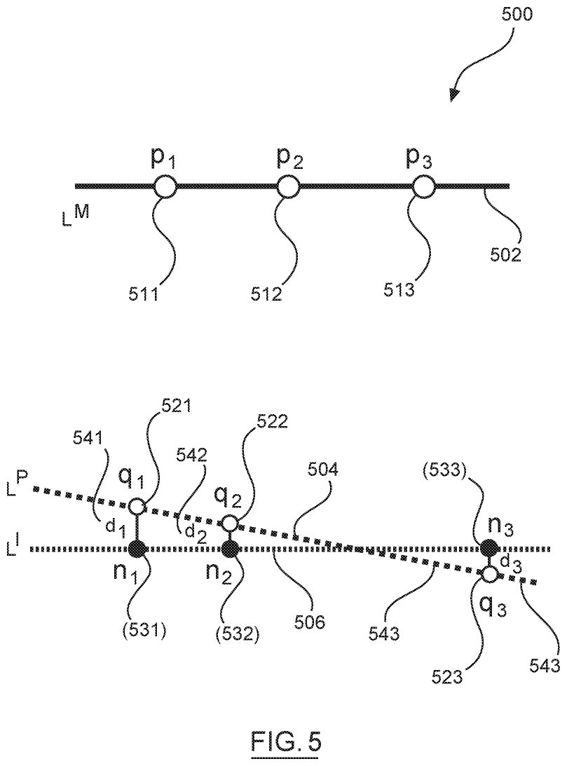

With reference to FIG. 5, a first representation 500 depicts an exemplary identified lane (“L^{M}”) 500 from the map (e.g., from the stored values 134 of FIG. 1). As shown in FIG. 5, exemplary randomly selected points include a first point (p₁) 511, a second point (p₂) 512, and a third point (p₃) 513. While FIG. 5 depicts three selected points, it will be appreciated that the number of selected points may vary in other embodiments.

With reference back to FIG. 3, an initial projection is performed for the lane (step 316). Specifically, in various embodiments, the processor 122 of FIG. 1 (e.g., as part of the processing module 220 of FIG. 2) performs an initial projection for the lane using the randomly selected points of step 314 along with the initialized camera parameters of step 310, to thereby generate a projected lane from the map. In various embodiments, calibration parameters are utilized for projection from a three-dimensional world to a two-dimensional image, for example using techniques known in the art.

With reference again to FIG. 5, during step 316, the projected lane (“L^{P}”) 504 is generated based on the lane from the map L^{M} 502. Specifically, in certain embodiments, each of the selected points p₁ 511, p₂ 512, and p₃ 513 of the lane from the map L^{M} 502 are projected as corresponding projected points q₁ 521, q₂ 522, and q₃ 523 onto the projected lane L^{P} 504 in accordance with the following equation:

qᵢ=R pᵢ+T (Equation 1),

in which “pᵢ” represents one of the randomly selected points from the lane from the map L^{M} 502, “qᵢ” represents a corresponding projected point on the projected lane L^{P} 504, and “R” and “T” represent the initialized parameter values of the rotation matrix and translation vector of step 310, respectively. Also in various embodiments, the various projected points (q) are used to construct the projected lane L^{P} 504.

With reference back to FIG. 3, in certain embodiments, nearest neighbor points are selected between the projected lane of step 316 and a corresponding lane in the camera image (step 318). Specifically, in various embodiments, the processor 122 of FIG. 1 (e.g., as part of the processing module 220 of FIG. 2) selects points along the lane in the camera image that are closest to corresponding projected points of the projected lane of step 316.

As depicted in FIG. 5, the lane in the camera image is denoted as L^{I} 506. Also as depicted in FIG. 5, nearest neighbor points “n₁” 531, “n₂” 532, and “n₃” 533 are selected from the lane in the camera image L¹ 506 as corresponding to points q₁ 521, q₂ 522, and q₃ 533, respectively of the projected lane L^{P} 504, as being the closest corresponding points along L¹ 506 to the respective points along lane L^{P} 504.

Returning to FIG. 3, in step 320, respective distances are calculated between each of the nearest neighbor points of step 318 and the corresponding projected points of step 318. Specifically, in various embodiments, the processor 122 of FIG. 1 (e.g., as part of the processing module 220 of FIG. 2) calculates respective distances for each of these pairs of corresponding points.

As depicted in FIG. 5, the respective distances include: (i) a first distance “d₁” 541 between corresponding points q₁ 521 (of lane L^{P} 504) and n₁ 531 (of lane L¹ 506); (ii) a second distance “d₂” 542 between corresponding points q₂ 522 (of lane L^{P} 504) and n₂ 532 (of lane L¹ 506); and (iii) a third distance “d₃” 543 between corresponding points q₃ 523 (of lane L^{P} 504) and n₃ 533 (of lane L¹ 506).

Returning back to FIG. 3, updated parameter values are calculated (step 322). In various embodiments, the processor 122 of FIG. 1 (e.g., as part of the processing module 220 of FIG. 2) calculates updated parameter values for the rotation matrix “R” and the translation vector “T” in accordance with the following equation:

$$arg {min}_{R , T} {\sum }_{i = 1}^{k} {d}_{i} , \qquad ( Equation 2 )$$

in which “dᵢ” represents the respective distances for each of the selected pairs of points (e.g., as calculated in step 320), “k” represents the number of selected pairs of points, “R” represents the updated rotation matrix, and “T” represents the updated translation vector. An exemplary implementation of the calculating of the updated parameter values is depicted in FIG. 8, and is described further below in connection therewith.

In various embodiments, next, during step 328, the cameras 102 are calibrated with the latest updated values of the rotation matrix “R” and the translation vector “T” from step 322. Also in various embodiments, the calibrations are performed by the processor 122 of FIG. 1 (e.g., as part of the processing module 220 of FIG. 2).

In various embodiments, updated projections are performed based on the updated camera calibrations (step 330). For example, in various embodiments, the processor 122 of FIG. 1 (e.g., as part of the processing module 220 of FIG. 2) provides updated projections of the camera images onto a three-dimensional space using the updated rotation matrix “R” and translation vector “T” calibrations from step 328.

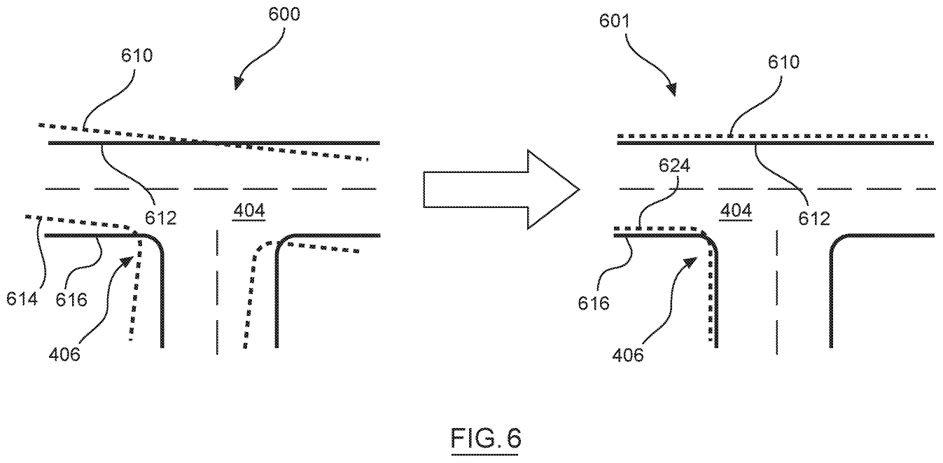

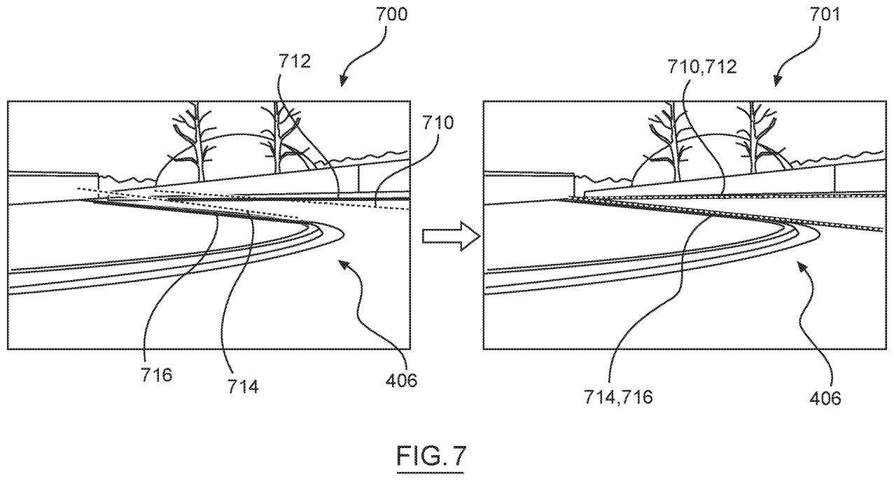

With reference to FIGS. 6 and 7, examples are provided with respect to improved projections that may be provided using the updated rotation matrix “R” and translation vector “T” calibrations. For example, with respect to FIG. 6, during a first projection 600, (i) a first projected lane 610 is shown deviating from a corresponding known first lane 612; and (ii) a second projected lane 614 is shown deviating from a corresponding known second lane 616, both as part of an initial projection using the initial calibration parameter values of step 310, due to initial calibration errors. By comparison, also as shown in FIG. 6, during a second projection 601 (i.e., after the updating of the “R” and “T” calibration values for the calibration of step 328), (i) an updated first projected lane 620 is shown as being aligned with the known first lane 612; and (ii) an updated second projected lane 624 is shown as being aligned with the known second lane 616, due to the correction of the initial calibration errors.

Similarly, with respect to FIG. 7, during a first projection 700, (i) a first projected lane 710 is shown deviating from a corresponding known first lane 712; and (ii) a second projected lane 714 is shown deviating from a corresponding known second lane 716, both as part of an initial projection using the initial calibration parameter values of step 310, due to initial calibration errors. By comparison, also as shown in FIG. 7, during a second projection 701 (i.e., after the updating of the “R” and “T” calibration values for the calibration of step 328), (i) an updated first projected lane 720 is shown as being aligned with the known first lane 712; and (ii) an updated second projected lane 724 is shown as being aligned with the known second lane 716, due to the correction of the initial calibration errors.

With reference back to FIG. 3, in various embodiments, various vehicle actions may be performed (step 332). For example, in various embodiments, the projections of the images of the roadway and objects (e.g., including possible detected nearby vehicles, such as the target vehicle 402 of FIG. 4) onto the three-dimensional space using the updated calibration parameters can be used in various embodiments to initiate one or more vehicle actions, as appropriate, such as automatic braking and/or steering, automatic notifications, and so on (e.g., if the target vehicle 402 is approaching the vehicle 100 and/or its intended path), and so on.

In various embodiments, the various steps of the process 300 may continue throughout a current vehicle drive or ignition cycle, and then terminate at step 334 upon completion thereof.

With reference to FIG. 8, an exemplary sub-process is provided for determining the updated parameter values of step 322 (e.g., using Equation 2, described above), in accordance with an exemplary embodiment. In various embodiments, the steps of the sub-process of FIG. 8 are performed using the processing module 220 of FIG. 2, for example via the processor 122 of FIG. 1.

Specifically, as depicted in FIG. 8, in one embodiment, current “R” and “T” values are obtained (step 802). In various embodiments, the updated “R” and “T” values are calculated using Equation 2 above, and the most recent values from steps 314-320 of FIG. 3, using the processing module 220 of FIG. 2 (for example via the processor 122 of FIG. 1). In certain embodiments, the “R” and “T” values comprise existing parameters “R” and “T” that have already been attained for the point n_1, n_2, and n_3 on the detected lane in the image from FIG. 5, which correspond to point P_1, P_2, P_3, in the original map in the three-dimensional world.

Also in various embodiments, these pairs of points are then used to recalculate the calibration parameters “R” and “T” with standard camera calibration processes (step 804). In various embodiments, these values are calculated using the processing module 220 of FIG. 2 (for example via the processor 122 of FIG. 1). In various embodiments, a number of pairs of points may be utilized in order to obtain more accurate results. In certain embodiments at least five pairs of points (or more), are utilized.

In various embodiments, the most recent “R” and “T” values from step 802 are further refined (step 806). In certain embodiments, once new “R” and “T” matrices are obtained, then the new “R” and “T” values are utilized to project again the point P1, P2, P3 on to the page and find another set of nearest points n_1, n_2, n_3. Also in certain embodiments, once the new pairs of points are found, they can then be used to compute additional “R” and “T” matrices. In various embodiments, this updating is provided a number of times either (a) a maximum number of iterations is reached; or (b) the location of points n_1, n_2, n_3 does not change more than a predetermined threshold amount after each iteration (i.e. the calibration error is small enough).

In certain embodiments, the further refinements of the “R” and “T” values in step 806 include a sequence of steps (or sub-steps) 808-816, as set forth in FIG. 8. For example, in one embodiment, the further refinements are made based on the calculation of one or more errors with respect to the parameter values, as set forth below.

In certain embodiments, one or more errors for “R” and “T” values are calculated (step 808). In certain embodiments, the processor 122 of FIG. 1 (e.g., as part of the processing module 220 of FIG. 2) calculates measures of difference between the initialized values of “R” and “T” of step 310 (or the recalculated “R” and “T” values of step 804 using standard camera calibration processes) versus the updated values of “R” and “T” of step 802 (for example, to determine whether lanes L^{I} 506 and L^{P} 504 are properly aligned). In certain embodiments, the respective differences between the current and prior “R” and “T” values are measured in percentage terms; however, this may vary in other embodiments.

In certain embodiments, a determination is made as to whether the errors are less than their respective predetermined thresholds (step 810). In certain embodiments, the processor 122 of FIG. 1 (e.g., as part of the processing module 220 of FIG. 2) determines whether (i) the difference (or percentage difference) between the current and prior rotation matrix “R” values is less than a first predetermined threshold value; and (ii) the difference (or percentage difference) between the current and prior translation vector “T” values is less than a second predetermined threshold value.

In certain embodiments, if is determined that one or more errors of step 808 are greater than or equal to their respective threshold values, then at step 812, the process returns to step 312 of FIG. 3 in a new iteration. Specifically, in certain embodiments, if either the rotation matrix “R” error (e.g., the difference, or percentage difference, in the initial “R” value versus the updated “R” value) is greater than or equal to its predetermined threshold value, or if the translation vector “T” error (e.g., the difference, or percentage difference, in the initial “T” value versus the updated “T” value) is greater than or equal to its predetermined threshold value, or both, then the latest “R” and “T” values are stored as the latest parameters (e.g., as the latest “initialized parameter values” of step 310 or as the latest recalculated values using the standard camera calibration processes of step 804), and the process returns to step 312 of FIG. 3. Steps 312-810 (of FIGS. 3 and 8) thereafter repeat in a new iteration (or iterations) until the error values for both the rotation matrix “R” and the translation vector “T” are both less than their respective predetermined threshold values, in certain embodiments. Accordingly, in certain embodiments, an iterative process is utilized to continually update the projections of the roadways and detected objects onto the three-dimensional space, thereby ultimately achieving convergence of the projected lanes with the known positions of the lanes (e.g., from the map data).

Also in certain embodiments, once it is determined in an iteration of step 810 that the errors are less than their respective values (e.g., for both the rotation matrix “R” and the translation vector “T” values), then the lanes L^{I} 506 and L^{P} 504 are deemed to be properly aligned. As such, in various embodiments, the most recent current “R” and “T” values are designated as the final refined values of “R” and “T” (step 814), and, at step 816, the process proceeds to step 328 of FIG. 3 (discussed above).

Accordingly, methods, systems, and vehicles are provided for calibrating cameras for vehicles. In various embodiments, camera images of detected objects (including target vehicles and features of roadways) are projected onto a three-dimensional space. In various embodiments, an iterative process is utilized to minimize the alignment parameter errors and to update the calibration parameters accordingly for the cameras. In various embodiments, updated projections of the roadways and detected objects are generated using the updated alignment parameter values, and may be used to initiate one or more vehicle actions as may be warranted under the circumstances.

It will be appreciated that the systems, vehicles, and methods may vary from those depicted in the Figures and described herein. For example, the vehicle 100, the cameras 102, the control system 104, and/or components thereof of FIGS. 1 and 2 may vary in different embodiments. It will similarly be appreciated that the steps of the process 300 may differ from those depicted in FIG. 3 (and/or the sub-process of FIG. 8), and/or that various steps of the process 300 may occur concurrently and/or in a different order than that depicted in FIG. 3 (and/or the sub-process of FIG. 8), in various embodiments. It will similarly be appreciated that the various implementations of FIGS. 4-7 may also differ in various embodiments.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method comprising:
obtaining a camera image from a camera onboard a vehicle;
detecting an object in proximity to the vehicle from the camera image;
obtaining map data relating to the detected object;
performing, via a processor, an initial projection using the map data and initial values of calibration parameters for the camera; and
updating, via the processor, values of the calibration parameters using a comparison of the initial projection with the camera image.

2. The method of claim 1, wherein:
the step of detecting the object comprises detecting a feature of a roadway in proximity to the vehicle; and
the step of obtaining the map data comprises obtaining the map data relating the feature of the roadway.

3. The method of claim 2, wherein:
the step of performing the initial projection comprises performing, via the processor, an initial lane projection using a known lane from the map data and the initial values of calibration parameters for the camera; and
the step of updating the calibration parameters comprises updating, via the processor, the calibration parameters using a comparison of the initial lane projection with a corresponding lane from the camera image.

4. The method of claim 3, wherein the step of performing the initial projection comprises:
randomly selecting a plurality of points along the known lane from the map data; and
generating an initial projected lane using the set of points and the initial values of the calibration parameters, utilizing the following equation: qᵢ=R pᵢ+T, in which “pᵢ” represents one of the plurality of randomly selected points from the known lane from the map data, “qᵢ” represents a corresponding projected point on the initial projected lane, “R” represents an initial value of a rotation matrix for the camera, and “T” represents an initial value of a translation vector for the camera.

5. The method of claim 4, wherein the step of updating the calibration parameters comprises:
identifying corresponding nearest neighbor points between the known lane from the map data and corresponding projected points of the initial projected lane;
calculating respective distances between each of the projected points and their corresponding nearest neighbor points; and
determining the calibration parameters based on the distances.

6. The method of claim 5, wherein the calibration parameters comprise a rotation matrix “R” for the camera and a translation vector “T” for the camera, and the step of determining the calibration parameters is performed in accordance with the following equation:
$$arg {min}_{R , T} {\sum }_{i = 1}^{k} {d}_{i} ,$$
in which “dᵢ” represents the respective distances between each of the projected points and their corresponding nearest neighbor points for each of a plurality of selected pairs of points from the known lane and the initial projected lane, and “k” represents a number of selected pairs of points.

7. The method of claim 1, further comprising:
calculating an error for the calibration parameters based on the initial values of the calibration parameters and the updating of values of the calibration parameters; and
providing further updates for the calibration parameters in an iterative fashion using subsequent projections using the map data and the updated values of the calibration parameters, until the error for the calibration parameters is less than a predetermined threshold, to thereby align the initial projection and the camera image.

8. The method of claim 1, further comprising:
providing updated projections of the camera image onto a three-dimensional space using the updated values of the calibration parameters; and
taking a vehicle action, in accordance with instructions provided via the processor, based on the updated projections.

9. A system comprising:
an image module configured to:
obtain a camera image from a camera onboard a vehicle;
detect an object in proximity to the vehicle from the camera image; and
obtain map data relating to the detected object; and
a processing module configured to:
perform, via a processor, an initial projection using the map data and initial values of calibration parameters for the camera; and
update, via the processor, values of the calibration parameters using a comparison of the initial projection with the camera image.

10. The system of claim 9, wherein:
the image module is configured to:
detect a feature of a roadway in proximity to the vehicle; and
obtain the map data relating the feature of the roadway; and
the processing module is configured to:
perform an initial lane projection using a known lane from the map data and the initial values of calibration parameters for the camera; and
update the calibration parameters using a comparison of the initial lane projection with a corresponding lane from the camera image.

11. The system of claim 10, wherein the processing module is configured to:
randomly select a plurality of points along the known lane from the map data; and
generate an initial projected lane using the set of points and the initial values of the calibration parameters, utilizing the following equation: qᵢ=R pᵢ+T, in which “pᵢ” represents one of the plurality of randomly selected points from the known lane from the map data, “qᵢ” represents a corresponding projected point on the initial projected lane, “R” represents an initial value of a rotation matrix for the camera, and “T” represents an initial value of a translation vector for the camera.

12. The system of claim 11, wherein the calibration parameters comprise a rotation matrix “R” for the camera and a translation vector “T” for the camera, and the processing module is configured to:
identify corresponding nearest neighbor points between the known lane from the map data and corresponding projected points of the initial projected lane;
calculate respective distances between each of the projected points and their corresponding nearest neighbor points; and
determine the calibration parameters based on the distances, in accordance with the following equation:
$$arg {min}_{R , T} {\sum }_{i = 1}^{k} {d}_{i} ,$$
in which “dᵢ” represents the respective distances between each of the projected points and their corresponding nearest neighbor points for each of a plurality of selected pairs of points from the known lane and the initial projected lane, and “k” represents a number of selected pairs of points.

13. The system of claim 9, wherein the processing module is configured to:
calculate an error for the calibration parameters based on the initial values of the calibration parameters and the updating of values of the calibration parameters; and
provide further updates for the calibration parameters in an iterative fashion using subsequent projections using the map data and the updated values of the calibration parameters, until the error for the calibration parameters is less than a predetermined threshold, to thereby align the initial projection and the camera image.

14. The system of claim 9, wherein the processing module is configured to:
provide updated projections of the camera image onto a three-dimensional space using the updated values of the calibration parameters; and
provide instructions for taking a vehicle action, based on the updated projections.

15. A vehicle comprising:
a body;
a propulsion system configured to generate movement of the body;
a camera disposed onboard the vehicle and configured to generate a camera image in which an object is detected onboard the vehicle;
a memory configured to store map data relating to the detected object; and
a processor disposed onboard the vehicle and configured to:
perform an initial projection using the map data and initial values of calibration parameters for the camera; and
update values of the calibration parameters using a comparison of the initial projection with the camera image.

16. The vehicle of claim 15, wherein:
the detected object comprises a feature of a roadway in proximity to the vehicle;
the map data relates to the feature of the roadway; and
the processor is configured to:
perform an initial lane projection using a known lane from the map data and the initial values of calibration parameters for the camera; and
update the calibration parameters using a comparison of the initial lane projection with a corresponding lane from the camera image.

17. The vehicle of claim 16, wherein the processor configured to:
randomly select a plurality of points along the known lane from the map data; and
generate an initial projected lane using the set of points and the initial values of the calibration parameters, utilizing the following equation: qᵢ=R pᵢ+T, in which “pᵢ” represents one of the plurality of randomly selected points from the known lane from the map data, “qᵢ” represents a corresponding projected point on the initial projected lane, “R” represents an initial value of a rotation matrix for the camera, and “T” represents an initial value of a translation vector for the camera.

18. The vehicle of claim 17, wherein the calibration parameters comprise a rotation matrix “R” for the camera and a translation vector “T” for the camera, and the processor is configured to:
identify corresponding nearest neighbor points between the known lane from the map data and corresponding projected points of the initial projected lane;
calculate respective distances between each of the projected points and their corresponding nearest neighbor points; and
determine the calibration parameters based on the distances, in accordance with the following equation:
$$arg {min}_{R , T} {\sum }_{i = 1}^{k} {d}_{i} ,$$
in which “dᵢ” represents the respective distances between each of the projected points and their corresponding nearest neighbor points for each of a plurality of selected pairs of points from the known lane and the initial projected lane, and “k” represents a number of selected pairs of points.

19. The vehicle of claim 15, wherein the processor is configured to:
calculate an error for the calibration parameters based on the initial values of the calibration parameters and the updating of values of the calibration parameters; and
provide further updates for the calibration parameters in an iterative fashion using subsequent projections using the map data and the updated values of the calibration parameters, until the error for the calibration parameters is less than a predetermined threshold, to thereby align the initial projection and the camera image.

20. The vehicle of claim 15, wherein the processor is configured to:
provide updated projections of the camera image onto a three-dimensional space using the updated values of the calibration parameters; and
provide instructions for taking a vehicle action, based on the updated projections.
